(19) United States
(12) Patent Application Publication
(10) Pub. No.: US 2026/0050428 A1
(43) Pub. Date: Feb. 19, 2026

(54) METHODS, SYSTEMS, AND DEVICES FOR HIGH-LEVEL MODEL DRIVEN INFRASTRUCTURE DEFINITION AND PROVISIONING

(71) Applicant: JPMorgan Chase Bank, N.A., New York, NY (US)

(72) Inventors: Kevin Seaman, Olathe, KS (US); Naga Venkata Shashi Kanth Mukthinuthalapati, Monmouth Junction, NJ (US); Dhruv Patel, Morris Plains, NJ (US); John Milone, Fort Lee, NJ (US); Kalyan Mudumbai, Manalapan, NJ (US); Trevor Samaroo, Kings, NY (US); Arjun N. Doss, Frisco, TX (US); Viktor Gadachek, Fair Lawn, NJ (US)

(73) Assignee: JPMorgan Chase Bank, N.A., New York, NY (US)

(21) Appl. No.: 18/804,692

(22) Filed: Aug. 14, 2024

(51) Int. Cl. G06F 8/60; G06F 8/71

(52) U.S. Cl. CPC G06F 8/60; G06F 8/71

(57) ABSTRACT

Aspects of the subject disclosure may include, for example, obtaining a model file and a context file associated with an environment-as-code (EaC) service, committing the model file and the context file utilizing a source control software service, and in response to the committing, building a set of instructions as part of a pipeline associated with the EaC service for utilizing a continuous integration and continuous deployment (CI/CD) software application. Further embodiments may include assembling infrastructure-as-code (IaC) software from a curated library of software patterns based on the model file and the EaC service, configuring a group of workspaces for a IaC provider software application based on the set of instructions as part of the pipeline, and providing provisioning instructions to a cloud provider server to provision computing resources based on the group of workspaces. Other embodiments are disclosed.

### FIELD OF THE DISCLOSURE

The subject disclosure relates to methods, systems, and devices for high-level model driven infrastructure definition and provisioning.

### BACKGROUND

The rise of cloud computing as well as other technological advancements such as containerization have driven a paradigm shift in the way in which software application infrastructure is provisioned and managed. Because much of modern software infrastructure management has shifted to code-based structures and automation, the industry trend had been to transition infrastructure responsibilities from operations teams toward developers-seeking so-called “full stack” developers. Most existing infrastructure-as-code (IaC) tools accomplish their “as code” by applying a thin node-based interface onto existing concepts of infrastructure configuration. This forces developers to gain expertise in entire new domains such as networking, storage, compute, infrastructure security, etc. to be successful. This significantly increases the cognitive load for an average developer.

### SUMMARY OF THE DISCLOSURE

The subject disclosure describes, among other things, illustrative embodiments for obtaining a model file and a context file associated with an environment-as-code (EaC) service, committing the model file and the context file utilizing a source control software service, and in response to the committing, building a set of instructions as part of a pipeline associated with the EaC service for utilizing a continuous integration and continuous deployment (CI/CD) software application. Further embodiments may include assembling IaC instructions from a curated library of software patterns based on the model file and the EaC service utilizing the CI/CD software application, configuring a group of workspaces for an IaC provider software application based on the set of instructions as part of the pipeline, and providing provisioning instructions to a cloud provider server to provision computing resources based on the group of workspaces. Other embodiments are described in the subject disclosure.

One or more aspects of the subject disclosure include a device, comprising a processing system including a processor, and a memory that stores executable instructions that, when executed by the processing system, facilitate performance of operations. The operations may comprise obtaining a model file and a context file associated with an EaC service, committing the model file and the context file utilizing a source control software service, and in response to the committing, building a set of instructions as part of a pipeline associated with the EaC service for utilizing a CI/CD software application. Further operations may comprise assembling IaC instructions based on the model file and the EaC service utilizing the CI/CD software application, configuring a group of workspaces for a IaC provider software application based on the set of the instructions pipeline, and providing provisioning instructions to a cloud provider server to provision computing resources based on the group of workspaces.

One or more aspects of the subject disclosure include a non-transitory machine-readable medium, comprising executable instructions that, when executed by a processing system including a processor, facilitate performance of operations. The operations may comprise obtaining a model file and a context file associated with an EaC service, committing the model file and the context file utilizing a source control software service, and identifying a group of EaC software patterns based on the model file. Further operations may comprise identifying a first portion of the group of EaC software patterns in a cache of EaC software patterns, and building a set of instructions as part of a pipeline associated with the EaC service for utilizing a CI/CD software application. The building of the set of instructions as part of the pipeline may comprise reusing the first portion of the group of EaC software patterns from the cache of EaC software patterns and building a second portion of the group of EaC software patterns. Additional operations may comprise assembling IaC instructions from a curated library of software patterns based on the model file and the EaC service utilizing the CI/CD software application, configuring a group of workspaces for a IaC provider software application based on the set of the instructions as part of the pipeline, and providing provisioning instructions to a cloud provider server to provision computing resources based on the group of workspaces.

One or more aspects of the subject disclosure include a method. The method may comprise obtaining, by a processing system including a processor, a model file and a context file associated with an EaC service, storing, by the processing system, the model file and the context file utilizing a source control software service, and building, by the processing system, a set of instructions as part of a pipeline associated with the EaC service for utilizing a CI/CD software application. Further, the method may comprise assembling, by the processing system, IaC instructions from a curated library of software patterns based on the model file and the EaC service utilizing the CI/CD software application, configuring, by the processing system, a group of workspaces for a IaC provider software application based on the set of the instructions as part of the pipeline, and providing, by the processing system, provisioning instructions to a cloud provider server to provision computing resources based on the group of workspaces.

### BRIEF DESCRIPTION OF THE DRAWINGS

Reference will now be made to the accompanying drawings, which are not necessarily drawn to scale, and wherein:

FIG. 1A is a block diagram illustrating an exemplary, non-limiting embodiment of a software patterns interconnect model in accordance with various aspects described herein.

FIG. 1B is a block diagram illustrating an exemplary, non-limiting embodiment of a system in accordance with various aspects described herein.

FIG. 1C depicts an illustrative embodiment of a method in accordance with various aspects described herein.

FIG. 2 is a block diagram illustrating an exemplary, non-limiting embodiment in accordance with various aspects described herein.

FIG. 3 depicts an illustrative embodiment of a method in accordance with various aspects described herein.

FIG. 4 is a block diagram of an example, non-limiting embodiment of a computing environment in accordance with various aspects described herein.

### DETAILED DESCRIPTION

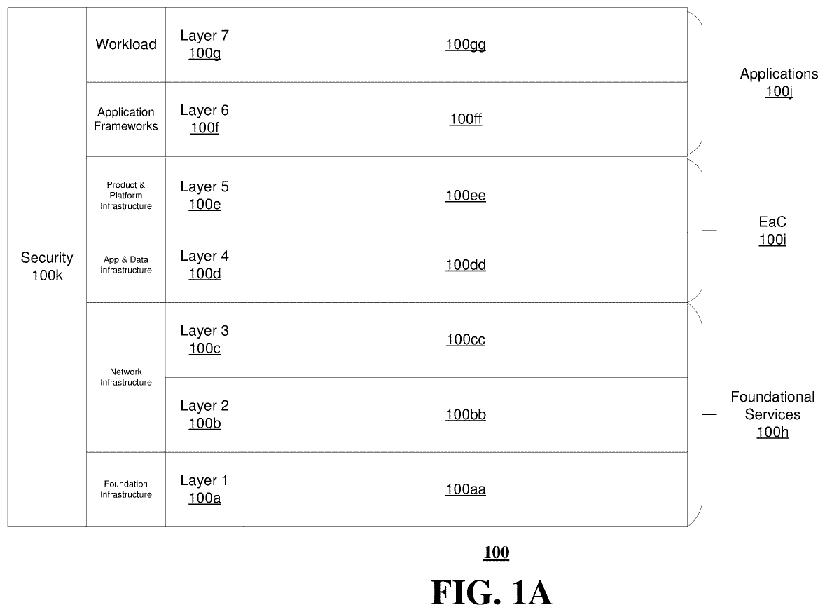

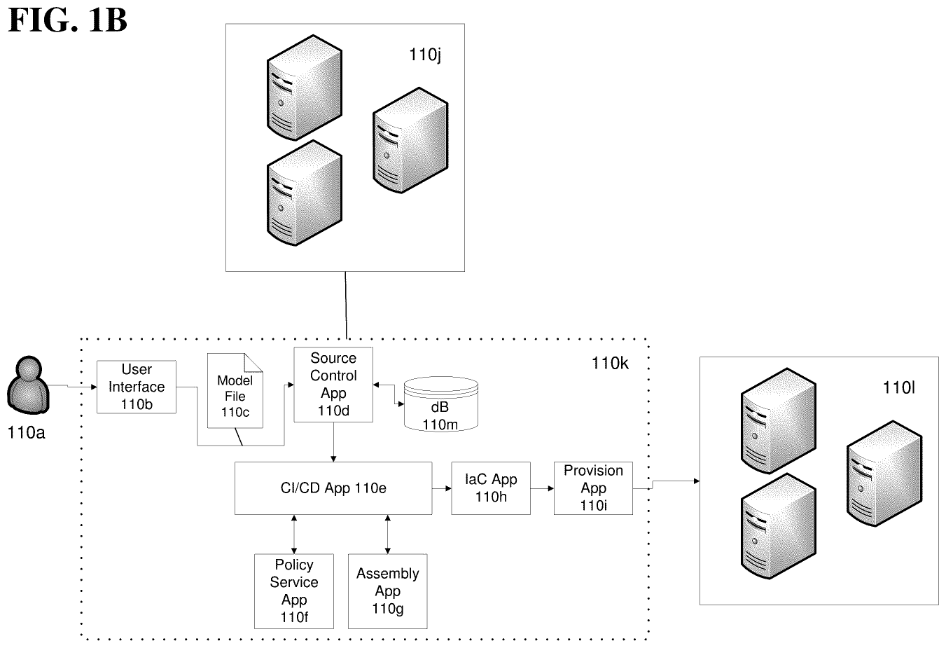

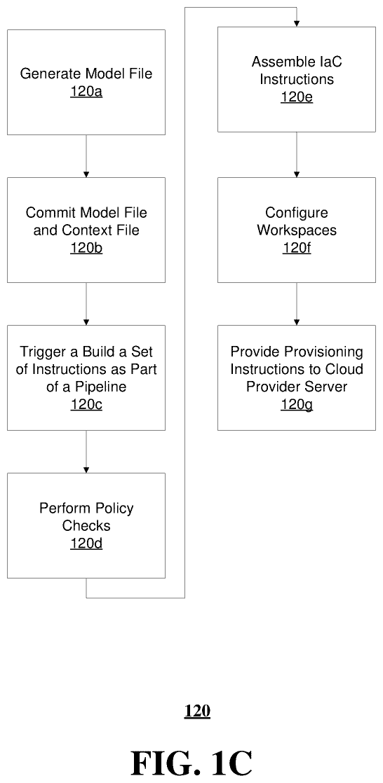

FIG. 1A illustrates a software patterns interconnect model 100. A software pattern may be a strategy coded in a software environment to solve a recurring problem. Further, each software pattern may describe the recurring problem and may describe a solution to that problem that may be reused for the recurring problem. Utilizing software patterns can more efficiently use the computing processing resources and memory resources of the computing environment developing the software patterns.

In one or more embodiments, the model 100 may comprise a number of layers such as seven layers. A first layer 100a may comprise foundation infrastructures. A second layer 100b and a third layer 100c may comprise network infrastructures. A fourth layer 100d may comprise application and data infrastructure. A fifth layer 100e may comprise a product and platform infrastructure. A sixth layer 100f may comprise application frameworks. A seventh layer 100g may comprise a workload (e.g., applications). A security function 100k (e.g., patterns) may span the seven layers. Further, the first layer 100a, the second layer 100b, and the third layers may include foundational services 100h. In addition, the fourth layer 100d and the fifth layer 100e may include the EaC 100i. Also, the sixth layer 100f and the seventh layer 100g may include applications 100j.

In one or more embodiments, the software patterns 100aa included in the first layer 100a may be associated with identity and access management (IAM) policies, enabling operational and risk auditing, governance, and compliance of a cloud computing account, creating virtual servers, continuous monitoring, security information and event management (SIEM), audit management, cloud computing account management, compute provisioning, cloud computing organization, and key management service.

In one or more embodiments, generally, the software patterns 100bb included in the second layers may be associated with external connectivity, third party connectivity, VPC to VPC connectivity, cloud to on-premises connectivity. More specifically, the software patterns 100bb may be associated with dedicated network connection, transit gateway (e.g., connects virtual private cloud (VPC) to on-premises networks through a central hub), virtual gateway (e.g., part of a virtual private cloud that provides edge routing for a cloud computing environment), and virtual private network (VPN) connection.

In one or more embodiments, the software patterns 100cc included in the third layer may be associated with only private subnetworks, public and private subnetworks, and private subnetworks with network address translation (NAT) gateway. More generally, the software patterns 100cc may be associated with virtual private clouds, subnetworks, gateways, route tables, network access control lists (NACLS), and security groups.

In one or more embodiments, the software patterns 100dd included in the fourth layer may be associated with application logging & monitoring, machine learning, data processing, data lake, Kubernetes cluster, persistence store, domain name system, and streaming. Specifically, the software patterns 100dd may be associated with managed services such as elastic Kubernetes service, lake formation, application load balancing, and relational database service.

In one or more embodiments, the software patterns 100ee included in the fifth layer may be associated with artificial intelligence (AI) platform, federated data lake, data pipelines, core services, microservices, event-based services, web applications, and custom application.

In one or more embodiments, the software patterns 100ff included in the sixth layer may be associated with application frameworks that include java frameworks, microservices frameworks, user interface frameworks, web development frameworks, and line of business specific managed platform.

In one or more embodiments, the software patterns 100gg included in the seventh layer may be associated with line of business applications.

In one or more embodiments, building and maintaining software applications in a cloud environment may be challenging to software developers. Solutions (e.g., provided by third parties) may be provided for the first layer, second layer, and third layer whereas applications (e.g., the sixth layer and seventh layer) may be the focus of software development teams. However, development regarding the fourth layer and the fifth layer continue to provide to be challenging. Whether building new, migrating existing, upgrading, or supporting an application, significant work happens in these layers for development teams. Performing these activities well and consistently is a key focus of development teams. Focusing on making it easier for developments teams regarding the fourth layer and the fifth layer may improve the user experience, increase speed/efficiency, and ensure better quality and consistency while allowing lines of business (LOB) to have autonomy that they need. EaC is a service/application that aims to address these challenges.

In one or more embodiments, EaC may be a service/application that helps developers define and manage public cloud environments. EaC may provide a straightforward way to model infrastructure using both primitives as well as software patterns. Further, EaC may orchestrate provisioning environments, checks policy compliance and nonfunctional requirements, provide a simplified upgrade experience, and may be built in modular and extensible fashion, integrating with toolsets and platforms.

In one or more embodiments, EaC may simplify the experience in designing, building, and operating public cloud infrastructure in a repeatable (e.g., reuseable) and consistent manner. Further, EaC may simplify the developer experience for infrastructure engineering on public cloud environments allowing them to focus more on application development. That is, EaC may reduce the number of steps to provision a typical infrastructure environment from, for example, 10 steps to 4 steps, thereby reducing the processing capacity/load and/or memory capacity/load of the computing environment developing the EaC service. In addition, EaC may enable building and updating a public cloud environment with repeatability, speed, and confidence. Also, EaC may ensure consistency across environments (e.g., development, test, product, etc.). Further, EaC may make it easier to perform infrastructure lifecycle management. In addition, EaC may scale architectural standards for greenfield efforts and migrations to the cloud. Also, EaC may strengthen resiliency, compliance, and security postures with preventive controls. Further, EaC may support extensibility for addition and changes by partners and customers. In addition, EaC may enable transparent usage of build modules with a model definition.

Referring to FIG. 1B, in one or more embodiments, system 110 may provision infrastructure resources in one or more cloud servers 110l utilizing an EaC service/application 110k. Aspects of EaC service/application 110k may be implemented by one or more servers 110j. Further, the EaC service/application may include several components that include, but are not limited to, files, applications, functions implemented by applications, and/or databases. A user interface 110b (e.g., a EaC command line interface (CLI)) may be utilized by a user 110a to generate a model file 110c (and/or context file). A source control service 110d (e.g., software application) may commit (e.g., store) the model file 110c and the context file to maintain version control. The model file 110c may be stored in a database 110m, file or directory, which is managed by the source control service 110d. A CI/CD software application 110e may be used to build or otherwise obtain a set of instructions, such as part of a pipeline. This building of the set of instructions may be based on the model file 110c committed by the source control service 110d. A policy service software application 110f may perform policy checks on the set of instructions built by the CI/CD software application 110c. Assembly software application 110g may be associated with EaC assembly of IaC instructions from a curated library of software patterns. Further, the CI/CD software application 110e may configure a workspace for an IaC software application 110h, which is associated with an IaC provider. A workspace may be a logical entity that encapsulates and maintains a separate state for each component/resource deployed by IaC. In addition, IaC software application 110h may include instructions for provisioning computing infrastructure to be added to the instructions built by the CI/CD software application 110c. A provisioning software application 110i may be used to provide provisioning instructions (as provided by the IaC software application 110h) to one or more cloud servers 110l to provision computing resources accordingly.

Referring to FIG. 1C, in one or more embodiments, aspects of method 120 may be implemented by system 110. Method 120 provides for provisioning infrastructure resources utilizing an EaC service/application 110k. A first step in the method 120, at 120a, may include a user 110a generating a model file 110c (and/or context file) utilizing a user interface 110b (e.g., a EaC command line interface (CLI)).

At 120b, the model file 110c and the context file may be committed (e.g., stored) to a source control service 110d (e.g., software application) to maintain version control. In some embodiments, the model file 110c may be stored in a database 110m, file, or directory that is managed by the source control service 110d.

At 120c, may include triggering (by the committing step) a build of a set of instructions as part of a pipeline for a CI/CD software application 110c.

At 120d, a policy service software application 110f may perform policy checks on the set of instructions that are part of the pipeline using EaC policies. For example, this may include reviewing or checking architectural patterns, compliance, and nonfunctional requirements (NFR) (e.g., collectively business rules enforcement).

At 120c, an assembly software application 110g (e.g., associated with the EaC) may assemble IaC instructions from a curated library of software patterns, which may leverage custom IaC software modules to be included to the set of instructions built by the CI/CD software application 110c.

At 120f, the CI/CD software application may configure workspaces for a IaC software application 110h associated with an IaC provider based on the set of the instructions as part of the pipeline. A workspace may be a logical entity that encapsulates and maintains a separate state for each component/resource deployed by IaC. The IaC software application 110h may include instructions for provisioning computing infrastructure (e.g., computer processing capacity, memory capacity, etc.) in addition to the set of instructions built by the CI/CD software application 110c.

At 120g, provisioning instructions may be provided to a cloud provider server utilizing a provisioning software application 110i. For example, the provisioning instructions may allow for provisioning computing resources in a cloud computing environment such as cloud servers 110l. Upon receiving the provisioning instructions one of the cloud servers 110l may then provision computing resources accordingly.

In one or more embodiments, the method 120 implemented by system 110 may provide a model-based approach for public cloud management. Further, the method 120 implemented by system 110 may provide assistive tooling and automation that may tie together the fragmented public cloud infrastructure provisioning and operations. In addition, the method 120 implemented by system 110 may define and leverage software patterns and best practices. Also, the method 120 implemented by system 110 may predict and prevent infrastructure build failures by evaluating models against heuristics developed through self-learning. Further, the method 120 implemented by system 110 may embed compliance policy checks as well as NFR checks into the provisioning process. In addition, the method 120 implemented by system 110 may integrate observability dashboards and pre-canned alarms. Also, the method 120 implemented by system 110 may provide generic utilities to help operations including infrastructure upgrades. Further, the method 120 implemented by system 110 may be implemented by one or more servers 110j, including virtual servers, residing in one location or spanning multiple locations. In addition, cloud servers 110l may include virtual servers, residing in one location or spanning multiple locations.

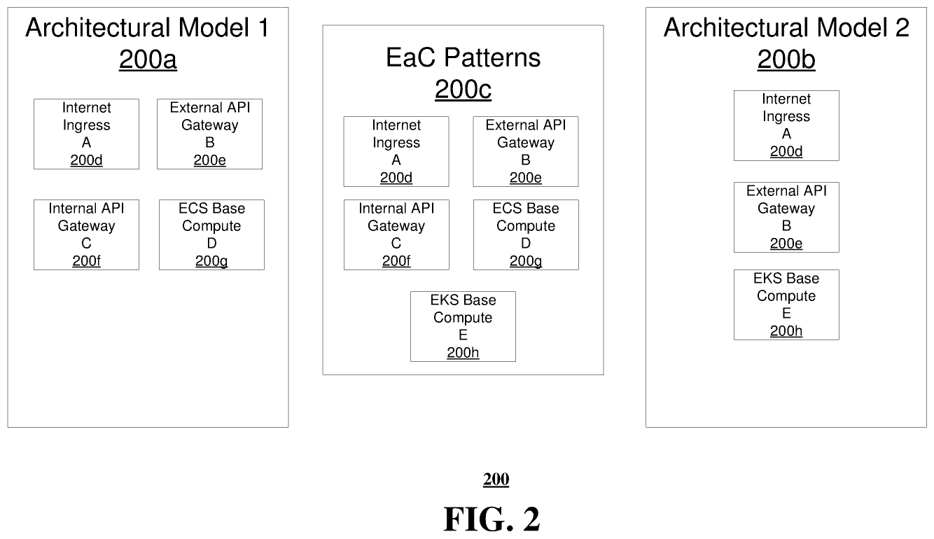

Referring to FIG. 2, in one or more embodiments, software patterns generated by process implemented by system 110 may be reused by different architectural models associated with an EaC service/application. For example, the process implemented by system 110 may previously generate EaC software patterns 200c and may store/cache them in the system 110 accordingly. The EaC software patterns 200c may include an Internet ingress software pattern 200d, an external API gateway software pattern 200e, an internal API gateway software pattern 200f, an elastic container service (ECS) base compute software pattern 200g, elastic Kubernetes service (EKS) base compute software pattern 200h. Further, the system 110 may generate an architectural model 200a associated with one EaC and an architectural model 200b associated with another EaC. Instead of developing/building the EaC software patterns for each architectural model 200a and architectural model 200b, the system 110 may check the cache and reuse a portion of the EaC software patterns 200c. That is, architectural model 200a may include the Internet ingress software pattern 200d, the external API gateway software pattern 200c, the internal API gateway software pattern 200f and the ECS base compute software pattern 200g while architectural model 200b may include the Internet ingress software pattern 200d, the external API gateway software pattern 200e, and the EKS base compute software pattern 200h.

Referring to FIGS. 1B, 1C and 2, in one or more embodiments, builds from the build of the set of instructions that are part of the pipeline (e.g., in the third step in FIG. 1C) may fail due to dependencies not being present or misconfigurations. In further embodiments, preventing such failures may save time and effort and improve efficiency. Some embodiments may include a command that runs against a deployment of a build and validates ways in which the build may fail. This may include validating cloud account resource limits such as IP availability and number of buckets. Further, it may include validating dependencies that are deployed as well as correct versions of modules associated with the build. For example, validating NAT gateway or base modules. In addition, this may include validating that a computing resource is in a state to be actioned. For example, it is not possible to delete a storage bucket that still has content or a base that still has an instance. Also, this may include validating deployment configurations for actions being applied as well as validating configuration and writings that are correct.

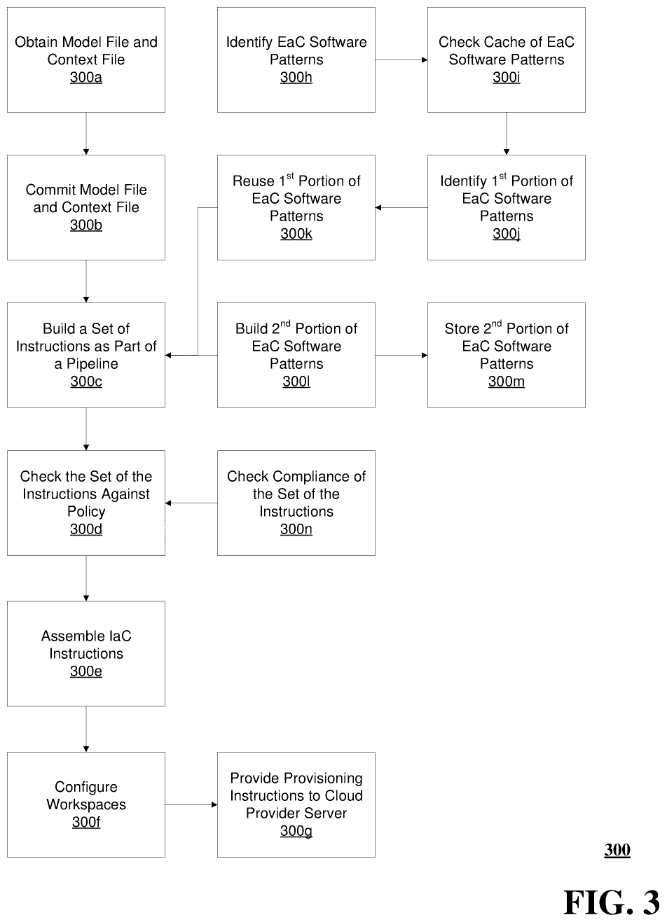

FIG. 3 depicts an illustrative embodiment of a method 300 in accordance with various aspects described herein. In one or more embodiments, method 300 may be implemented by a server or a group of servers. Method 300 may include the server, at 300a, obtaining a model file and a context file associated with an EaC service. Further, method 300 may include the server, at 300b, committing the model file and the context file utilizing a source control service. Also, method 300 may include the server, at 300c, building a set of instructions as part of pipeline associated with the EaC service utilizing a CI/CD software application.

In one or more embodiments, method 300 may include the server, at 300d, checking the set of the instructions as part of the pipeline against a policy associated with the EaC service utilizing a policy service software application. In some embodiments, the method 300 may include the server, at 300n, checking compliance of the set of the instructions as part of the pipeline with business rules utilizing the policy service software application. In further embodiments, the checking of the set of the instructions as part of the pipeline against a policy associated with the EaC service comprises checking compliance of the set of the instructions as part of the pipeline with business rules utilizing the policy service software application.

In one or more embodiments, the method 300 may include the server, at 300e, assembling IaC instructions from a curated library of software patterns based on the model file and the EaC service utilizing an assembly software application. Further, method 300 may include the server, at 300f, configuring a group of workspaces for an IaC software application based on the set of the instructions as part of the pipeline in which the IaC software application adds instructions for provisioning computing infrastructure to the set of instructions built by the CI/CD software application. In addition, method 300 may include the server, at 300g, providing provisioning instructions to a cloud provider server to provision computing resources utilizing a provisioning software application. Also, in response to receiving the provisioning instructions, the cloud provider server may provision computing resources accordingly.

In one or more embodiments, method 300 may include the server, at 300h, identifying a group of EaC software patterns based on the model file. Further, method 300 may include the server, at 300i, checking a cache of EaC software patterns based on the group of EaC software patterns. In addition, method 300 may include the server, at 300j, identifying a first portion of the group of EaC software patterns in the cache of EaC software patterns. Also, method 300 may include the server, at 300k, reusing the first portion of the group of EaC software patterns from the cache of EaC software patterns. In some embodiments, the building of the set of the instructions that are part of the pipeline comprises identifying a group of EaC software patterns based on the model file, checking a cache of EaC software patterns based on the group of EaC software patterns, identifying a first portion of the group of EaC software patterns in the cache of EaC software patterns, and reusing the first portion of the group of EaC software patterns from the cache of EaC software patterns.

In one or more embodiments, method 300 may include the server, at 300l, building a second portion of the group of EaC software patterns. In some embodiments, the building of the set of the instructions as part of the pipeline comprises building a second portion of the group of EaC software patterns. Further, method 300 may include the server, at 300m, storing the second portion of the group of EaC software patterns in the cache. This allows the second portions of the group of EaC software patterns to be reused for future implementations. Reuse of EaC software patterns reduces the amount of processing capacity and memory capacity needed to assemble the IaC instructions to provision the cloud computing resources.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. In some embodiments, one or more blocks may be performed in response to one or more blocks.

Further, portions of some embodiments may be combined with portions of other embodiments.

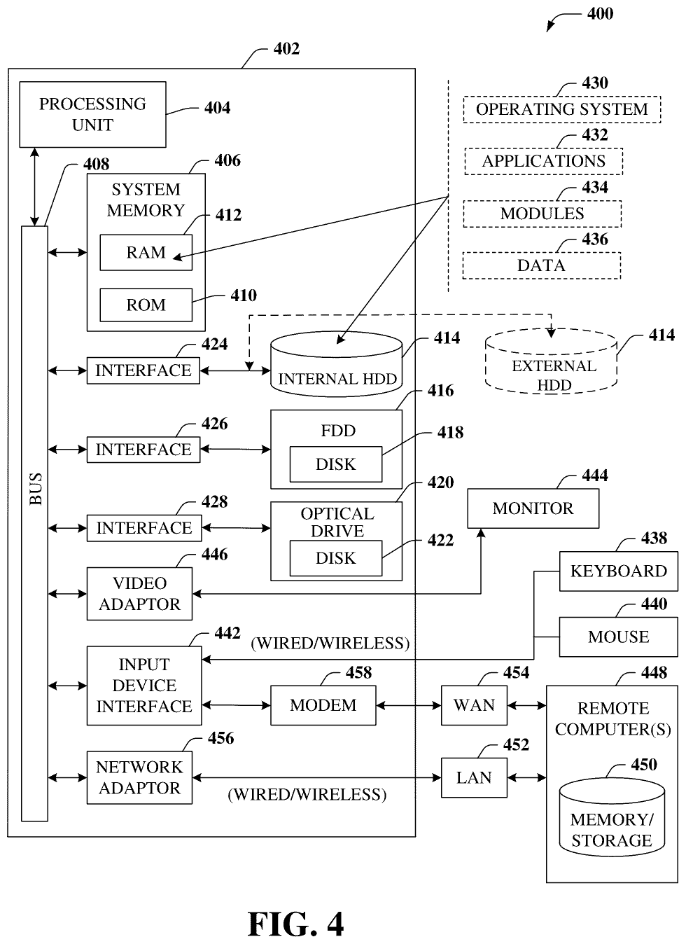

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure may be implemented. For example, computing environment 400 may facilitate in whole or in part generating EaC code to provision infrastructure computing resources in a cloud computing environment. Further, each of servers 110j, servers 110l, and database 110m may comprise a computing environment 400.

Generally, program modules comprise routines, programs, components, data structures, etc., that perform particular tasks or implement particular abstract data types. Moreover, those skilled in the art will appreciate that the methods may be practiced with other computer system configurations, comprising single-processor or multiprocessor computer systems, minicomputers, mainframe computers, as well as personal computers, hand-held computing devices, microprocessor-based or programmable consumer electronics, and the like, each of which may be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein may be also practiced in distributed computing environments where certain tasks are performed by remote processing devices that are linked through a communications network. In a distributed computing environment, program modules may be located in both local and remote memory storage devices.

Computing devices typically comprise a variety of media, which may comprise computer-readable storage media and/or communications media, which two terms are used herein differently from one another as follows. Computer-readable storage media may be any available storage media that may be accessed by the computer and comprises both volatile and nonvolatile media, removable and non-removable media. By way of example, and not limitation, computer-readable storage media may be implemented in connection with any method or technology for storage of information such as computer-readable instructions, program modules, structured data or unstructured data.

Computer-readable storage media may comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which may be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media may be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment may comprise a computer 402, the computer 402 comprising a processing unit 404, a system memory 406 and a system bus 408. The system bus 408 couples system components including, but not limited to, the system memory 406 to the processing unit 404. The processing unit 404 may be any of various commercially available processors. Dual microprocessors and other multiprocessor architectures may also be employed as the processing unit 404.

The system bus 408 may be any of several types of bus structure that may further interconnect to a memory bus (with or without a memory controller), a peripheral bus, and a local bus using any of a variety of commercially available bus architectures. The system memory 406 comprises ROM 410 and RAM 412. A basic input/output system (BIOS) may be stored in a non-volatile memory such as ROM, erasable programmable read only memory (EPROM), EEPROM, which BIOS contains the basic routines that help to transfer information between elements within the computer 402, such as during startup. The RAM 412 may also comprise a high-speed RAM such as static RAM for caching data.

The computer 402 further comprises an internal hard disk drive (HDD) 414 (e.g., EIDE, SATA), which internal HDD 414 may also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 may be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, may also be used in the example operating environment, and further, that any such storage media may contain computer-executable instructions for performing the methods described herein.

A number of program modules may be stored in the drives and RAM 412, comprising an operating system 430, one or more application programs 432, other program modules 434 and program data 436. All or portions of the operating system, applications, modules, and/or data may also be cached in the RAM 412. The systems and methods described herein may be implemented utilizing various commercially available operating systems or combinations of operating systems.

A user may enter commands and information into the computer 402 through one or more wired/wireless input devices, e.g., a keyboard 438 and a pointing device, such as a mouse 440. Other input devices (not shown) may comprise a microphone, an infrared (IR) remote control, a joystick, a game pad, a stylus pen, touch screen or the like. These and other input devices are often connected to the processing unit 404 through an input device interface 442 that may be coupled to the system bus 408, but may be connected by other interfaces, such as a parallel port, an IEEE 1394 serial port, a game port, a universal serial bus (USB) port, an IR interface, etc.

A monitor 444 or other type of display device may be also connected to the system bus 408 via an interface, such as a video adapter 446. It will also be appreciated that in alternative embodiments, a monitor 444 may also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 may operate in a networked environment using logical connections via wired and/or wireless communications to one or more remote computers, such as a remote computer(s) 448. The remote computer(s) 448 may be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which may connect to a global communications network, e.g., the Internet.

When used in a LAN networking environment, the computer 402 may be connected to the LAN 452 through a wired and/or wireless communication network interface or adapter 456. The adapter 456 may facilitate wired or wireless communication to the LAN 452, which may also comprise a wireless AP disposed thereon for communicating with the adapter 456.

When used in a WAN networking environment, the computer 402 may comprise a modem 458 or may be connected to a communications server on the WAN 454 or has other means for establishing communications over the WAN 454, such as by way of the Internet. The modem 458, which may be internal or external and a wired or wireless device, may be connected to the system bus 408 via the input device interface 442. In a networked environment, program modules depicted relative to the computer 402 or portions thereof, may be stored in the remote memory/storage device 450. It will be appreciated that the network connections shown are example and other means of establishing a communications link between the computers may be used.

The computer 402 may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This may comprise Wireless Fidelity (Wi-Fi) and BLUETOOTH® wireless technologies. Thus, the communication may be a predefined structure as with a conventional network or simply an ad hoc communication between at least two devices.

Wi-Fi may allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network may be used to connect computers to each other, to the Internet, and to wired networks (which may use IEEE 802.3 or Ethernet). Wi-Fi networks operate in the unlicensed 2.4 and 5 GHz radio bands for example or with products that contain both bands (dual band), so the networks may provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art may recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which may comprise computer-readable storage media and/or communications media, which two terms are used herein differently from one another as follows. Computer-readable storage media may be any available storage media that may be accessed by the computer and comprises both volatile and nonvolatile media, removable and non-removable media. By way of example, and not limitation, computer-readable storage media may be implemented in connection with any method or technology for storage of information such as computer-readable instructions, program modules, structured data or unstructured data. Computer-readable storage media may comprise the widest variety of storage media including tangible and/or non-transitory media which may be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

In addition, a flow diagram may include a “start” and/or “continue” indication. The “start” and “continue” indications reflect that the steps presented may optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than may be recognized by the second item. In a further example of indirect coupling, an action in a first item may cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, may be used in the subject disclosure. For instance, one or more features from one or more embodiments may be combined with one or more features of one or more other embodiments. In one or more embodiments, features that are positively recited may also be negatively recited and excluded from the embodiment with or without replacement by another structural and/or functional feature. The steps or functions described with respect to the embodiments of the subject disclosure may be performed in any order. The steps or functions described with respect to the embodiments of the subject disclosure may be performed alone or in combination with other steps or functions of the subject disclosure, as well as from other embodiments or from other steps that have not been described in the subject disclosure. Further, more than or less than all of the features described with respect to an embodiment may also be utilized.

What is claimed is:

1. A device, comprising:
a processing system including a processor; and
a memory that stores executable instructions that, when executed by the processing system, facilitate performance of operations, the operations comprising:
obtaining a model file and a context file associated with an environment-as-code (EaC) service;
committing the model file and the context file utilizing a source control service;
in response to the committing, building a set of instructions as part of a pipeline associated with the EaC service for utilizing a continuous integration and continuous deployment (CI/CD) software application;
assembling infrastructure-as-code (IaC) instructions from a curated library of software patterns based on the model file and the EaC service utilizing the CI/CD software application;
configuring a group of workspaces for a IaC provider software application based on the set of the instructions as part of the pipeline; and
providing provisioning instructions to a cloud provider server to provision computing resources based on the group of workspaces.

2. The device of claim 1, wherein the cloud provider server provisions the computing resources based on the provisioning instructions.

3. The device of claim 1, wherein the computing resources comprise one or more of groups of processors, groups of databases, caches, queues, storage media, networking components, identity principals and permissions, cloud components, or combinations thereof.

4. The device of claim 1, wherein the building of the set of the instructions that are part of the pipeline comprises:
identifying a group of EaC software patterns based on the model file;
checking a cache of EaC software patterns based on the group of EaC software patterns;
identifying a first portion of the group of EaC software patterns in the cache of EaC software patterns; and
reusing the first portion of the group of EaC software patterns from the cache of EaC software patterns.

5. The device of claim 4, wherein the building of the set of instructions as part of the pipeline comprises building a second portion of the group of EaC software patterns.

6. The device of claim 5, wherein the operations comprise storing the second portion of the group of EaC software patterns in the cache.

7. The device of claim 1, wherein the operations comprise checking the set of the instructions that are part of the pipeline against a policy associated with the EaC service utilizing a policy software application.

8. The device of claim 7, wherein the checking of the set of the instructions that are part of the pipeline against a policy associated with the EaC service comprises checking compliance of the set of the instructions that are part of the pipeline with business rules utilizing the policy software application.

9. A non-transitory machine-readable medium, comprising executable instructions that, when executed by a processing system including a processor, facilitate performance of operations, the operations comprising:
obtaining a model file and a context file associated with an environment-as-code (EaC) service;
committing the model file and the context file utilizing a source control service;
identifying a group of EaC software patterns based on the model file;
identifying a first portion of the group of EaC software patterns in a cache of EaC software patterns;
building a set of instructions as part of a pipeline associated with the EaC service for utilizing a continuous integration and continuous deployment (CI/CD) software application, wherein the building of the set of the instruction as part of the pipeline comprises reusing the first portion of the group of EaC software patterns from the cache of EaC patterns and building a second portion of the group of EaC software patterns;
assembling infrastructure-as-code (IaC) instructions from a curated library of software patterns based on the model file and the EaC service utilizing the CI/CD software application;
configuring a group of workspaces for a IaC provider software application based on the set of the instructions as part of the pipeline; and
providing provisioning instructions to a cloud provider server to provision computing resources based on the group of workspaces.

10. The non-transitory machine-readable medium of claim 9, wherein the cloud provider server provisions the computing resources based on the provisioning instructions.

11. The non-transitory machine-readable medium of claim 9, wherein the computing resources comprise one or more of groups of processors, groups of databases, caches, queues, storage media, networking components, identity principles and permissions, cloud components, or combinations thereof.

12. The non-transitory machine-readable medium of claim 9, wherein the operations comprise checking the cache of EaC software patterns based on the group of EaC software patterns.

13. The non-transitory machine-readable medium of claim 9, storing the second portion of the group of EaC software patterns in the cache.

14. The non-transitory machine-readable medium of claim 9, wherein the operations comprise checking the set of the instructions that are part of the pipeline against a policy associated with the EaC service utilizing a policy software application.

15. The non-transitory machine-readable medium of claim 14, wherein checking of the set of the instructions that are part of the pipeline against a policy associated with the EaC service comprises checking compliance of the set of the instructions that are part of the pipeline with business rules utilizing the policy software application.

16. A method, comprising:
obtaining, by a processing system including a processor, a model file and a context file associated with an environment-as-code (EaC) service;
storing, by the processing system, the model file and the context file utilizing a source control service;
building, by the processing system, a set of instructions as part of a pipeline associated with the EaC service for utilizing a continuous integration and continuous deployment (CI/CD) software application;
assembling, by the processing system, infrastructure-as-code (IaC) instructions from a curated library of software patterns based on the model file and the EaC service utilizing the CI/CD software application;
configuring, by the processing system, a group of workspaces for a IaC provider software application based on the set of the instructions as part of the pipeline; and
providing, by the processing system, provisioning instructions to a cloud provider server to provision computing resources based on the group of workspaces.

17. The method of claim 16, comprising checking, by the processing system, the set of the instructions that are part of the pipeline against a policy associated with the EaC service utilizing a policy software application.

18. The method of claim 17, wherein checking of the set of the instructions that are part of the pipeline against a policy associated with the EaC service comprises checking, by the processing system, compliance of the set of the instructions that are part of the pipeline with business rules utilizing the policy software application.

19. The method of claim 16, wherein the building of the set of the instructions that are part of the pipeline comprises:
identifying, by the processing system, a group of EaC software patterns based on the model file;
checking, by the processing system, a cache of EaC software patterns based on the group of EaC patterns;
identifying, by the processing system, a first portion of the group of EaC software patterns in the cache of EaC software patterns; and
reusing, by the processing system, the first portion of the group of EaC software patterns from the cache of EaC software patterns.

20. The method of claim 19, wherein the building of the set of the instructions that are part of the pipeline comprises building, by the processing system, a second portion of the group of EaC software patterns.
